(19) United States
(12) Patent Application Publication
(10) Pub. No.: US 2026/0087211 A1
(43) Pub. Date: Mar. 26, 2026

(54) GROUTING SUBGRADE WATER-VAPOR-HEAT COUPLING SIMULATIONMETHOD AND SYSTEM, DEVICE AND MEDIUM

(71) Applicant: Sun Yat-sen University, Guangzhou (CN)

(72) Inventors: Dingfeng CAO, Guangzhou (CN); Chengchao GUO, Guangzhou (CN); Fuming WANG, Guangzhou (CN); Fan YANG, Guangzhou (CN); Lei QIN, Guangzhou (CN)

(21) Appl. No.: 18/999,080

(22) Filed: Dec. 23, 2024

(30) Foreign Application Priority Data
Sep. 25, 2024 (CN) 202411338251.0

(51) Int. Cl. G06F 30/28; G06F 113/08

(52) U.S. Cl. CPC G06F 30/28; G06F 2113/08

(57) ABSTRACT

Provided are a grouting subgrade water-vapor-heat coupling simulation method and system, a device and a medium, including: constructing a subgrade water-vapor-heat coupling geometric model; acquiring a partial differential equation of a subgrade water-vapor-heat coupling process, and establishing a relationship between physical fields; setting a temperature and water boundary condition; performing mapping and free triangle mesh generation on the subgrade water-vapor-heat coupling geometric model to obtain a meshing model; selecting initial data, and performing a simulation solution on the meshing model to obtain a water-vapor-heat coupling simulation result; and analyzing the impact of a double-layer polyurethane grouting thermal insulation structure on a temperature distribution, a freeze-thaw cycle depth, and water migration of a subgrade.

### CROSS-REFERENCE TO RELATED APPLICATION

The present application claims priority to Chinese Patent Application No. 2024113382510, filed with the China National Intellectual Property Administration (CNIPA) on Sep. 25, 2024, the disclosure of which is incorporated herein by reference in its entirety.

### TECHNICAL FIELD

The present disclosure relates to the field of road engineering and, in particular, to a grouting subgrade water-vapor-heat coupling simulation method and system, a device and a medium.

### BACKGROUND

Permafrost refers to the rock and earth mass that has been frozen for two years or more and is formed under the long-term interaction of the complex atmosphere system. The permafrost is widely distributed globally and accounts for about 24% of the global land area. A subgrade built on the permafrost undergoes frost heave and thaw settlement deformation due to seasonal changes in the external climate, which seriously threatens the structural safety of the road and driving safety. Therefore, an effective thermal insulation measure is of great significance for subgrade engineering to prevent and control freeze-thaw weathering in a permafrost region.

At present, to solve the freeze-thaw weathering of the subgrade on the permafrost, the existing treatment measures are classified into two methods: active refrigeration and passive thermal insulation. The treatment measures of active refrigeration include a duct-ventilated subgrade, a slab-ventilated subgrade, and a thermal probe subgrade. Although the active refrigeration methods can reduce the temperature of the subgrade to some extent, these methods have obvious limitations. For example, the duct-ventilated subgrade introduces more heat into the subgrade due to the flow of hot air; the slab-ventilated subgrade may be prone to pore blockages under vehicle load; due to the characteristic of spot cooling of the thermal probe subgrade, the temperature field distribution in the subgrade is not uniform. These active refrigeration methods also have the general problems of large destruction and disturbance to the subgrade, long construction period, and high cost. In terms of passive thermal insulation measures, although the high-reflectivity surface of the subgrade can reduce the heat input from solar radiation to the subgrade, the high-reflectivity surface does not work at night; although a sun shield can reduce solar radiation, the cooling effect of the sun shield is greatly affected by strong winds, subgrade orientations, and terrain conditions; although thermal insulation materials such as expanded polystyrene (EPS) and extruded polystyrene (XPS) can effectively insulate the heat when used, in practical applications, the process of paving EPS boards and XPS boards on site is very time-consuming and interferes with traffic.

In summary, the existing art has certain limitations in the thermal insulation of subgrade engineering in the permafrost region, so there is an urgent need to provide a water-vapor-heat coupling simulation method for a subgrade having a double-layer polyurethane grouting thermal insulation structure to solve the problems of frost heave and thaw settlement caused by seasonal climate changes in subgrade engineering in the permafrost area.

### SUMMARY

The object of the present disclosure is to provide a grouting subgrade water-vapor-heat coupling simulation method and system, a device and a medium to quantitatively analyze the impact of a polyurethane layer on the temperature profile, the freeze-thaw depth, and the water distribution of the subgrade, thereby improving the accuracy of simulation analysis.

To solve the above problems, the present disclosure provides a grouting subgrade water-vapor-heat coupling simulation method and system, a device and a medium.

In a first aspect, the present disclosure provides a grouting subgrade water-vapor-heat coupling simulation method. The method includes the following steps.

A two-dimensional axisymmetric subgrade water-vapor-heat coupling geometric model is constructed according to a physical size and a position parameter of a subgrade and a physical size and a position parameter of a double-layer polyurethane grouting thermal insulation structure.

A partial differential equation of a subgrade water-vapor-heat coupling process is acquired, and a relationship between physical fields is established.

Material property parameters of different material layers in the subgrade water-vapor-heat coupling geometric model are defined, and a temperature and water boundary condition is set in the subgrade water-vapor-heat coupling geometric model.

Mesh generation is performed on the subgrade water-vapor-heat coupling geometric model by using mapping and a free triangular mesh, and mesh encryption is performed on a polyurethane thermal insulation layer and a surrounding region of the polyurethane thermal insulation layer to obtain a meshing model.

Soil temperatures and unfrozen water contents at different depths are selected as initial data, and a simulation solution is performed on the meshing model to obtain a water-vapor-heat coupling simulation result.

The impact of the double-layer polyurethane grouting thermal insulation structure on a temperature distribution, a freeze-thaw cycle depth, and water migration of the subgrade is analyzed according to the water-vapor-heat coupling simulation result.

In a further embodiment, the partial differential equation includes a water parabolic partial differential equation. The water parabolic partial differential equation is specifically as follows:

$${d}_{w} \frac{\partial S}{\partial t} + ∇ * {γ}_{w} + aS = {f}_{w}$$

$$where$$

$${d}_{w} = ( {θ}_{s} - {θ}_{r} ) [ 1 + \frac{{ρ}_{i}}{{ρ}_{l}} {B}_{i} ( T ) - \frac{{ρ}_{v}}{{ρ}_{l}} {B}_{i} ( T ) - \frac{{ρ}_{v}}{{ρ}_{l}} ]$$

$${γ}_{w} = - [ {K}_{lh} ∇ ( {h}_{m} + y ) + {K}_{lT} ∇ T ] - \frac{{ρ}_{v}}{{ρ}_{l}} [ {K}_{vh} ∇ {h}_{m} + {K}_{vT} ∇ T ]$$

$$a = ( \frac{{ρ}_{i}}{{ρ}_{l}} - \frac{{ρ}_{v}}{{ρ}_{l}} ) ( {θ}_{s} - {θ}_{r} ) \frac{\partial B}{\partial T} * \frac{\partial T}{\partial t}$$

$${f}_{w} = - [ ( \frac{{ρ}_{i}}{{ρ}_{l}} - \frac{{ρ}_{v}}{{ρ}_{l}} ) * {θ}_{r} * \frac{\partial B}{\partial T} * \frac{\partial T}{\partial t} ]$$

$${B}_{i} ( T ) = \frac{{θ}_{i}}{{θ}_{l}} = \{ \begin{matrix}1.1 {( \frac{T}{{T}_{f}} )}^{B} - 1 & T < {T}_{f} \\ 0 & T \geq {T}_{f}\end{matrix}$$

In the above equation, d_{w} denotes a damping coefficient of a water coefficient partial differential equation; S denotes saturation of soil; t denotes time in seconds; γ_{w} denotes a conservation flux source item of the water coefficient partial differential equation; α denotes a conservation flux convection coefficient; f_{w} denotes a source item of the water coefficient partial differential equation; θₛ denotes a saturated water content of a soil mass; θᵣ denotes a residual water content of the soil mass; ρᵢ denotes a density of ice; ρₗ denotes a density of liquid water; Bᵢ(T) denotes the ratio of a pore ice volume to an unfrozen water volume; ρᵥ denotes a density of vapor; Kₗₕ denotes an isothermal hydraulic conductivity derivative; ∇ denotes a Laplace operator; hₘ denotes a pressure head; y denotes an ordinate of spatial coordinates of the soil mass; K_{lT} denotes a non-isothermal hydraulic conductivity derivative; T denotes a temperature; Kᵥₕ denotes an isothermal vapor hydraulic conductivity; K_{vT} denotes a non-isothermal vapor hydraulic conductivity; θᵢ denotes a volume content of ice in soil; θₗ denotes a volume content of unfrozen water in soil; T_{f} denotes a freezing temperature; and B denotes an empirical constant.

In a further embodiment, the partial differential equation further includes a heat conduction parabolic partial differential equation, and the heat conduction parabolic partial differential equation is specifically as follows:

$${d}_{h} \frac{\partial T}{\partial t} + ∇ * ( - λ ∇ T - α T + {γ}_{h} ) = {f}_{h}$$

$$where$$

$${d}_{h} = \{ C - {L}_{i} {ρ}_{i} [ S ( {θ}_{s} - {θ}_{r} ) + {θ}_{r} ] \frac{\partial B}{\partial T} - {L}_{v} {ρ}_{v} [ S ( {θ}_{s} - {θ}_{r} ) + {θ}_{r} ] \frac{\partial B}{\partial T} \}$$

$$α = {C}_{l} {q}_{l} + {C}_{v} {q}_{v}$$

$${γ}_{h} = {L}_{v} {ρ}_{v} ∇ {q}_{v}$$

$${f}_{h} = ( {L}_{i} {ρ}_{i} B + {L}_{v} {ρ}_{v} B + {L}_{v} {ρ}_{v} ) [ ( {θ}_{s} - {θ}_{r} ) \frac{\partial S}{\partial t} ] .$$

In the above equation, dₕ denotes a damping coefficient of a heat conduction coefficient partial differential equation; A denotes a heat transfer coefficient of soil; α denotes an absorption coefficient; γₕ denotes a conservation flux source item of the heat conduction coefficient partial differential equation; fₕ denotes a source item of the heat conduction coefficient partial differential equation; C denotes a volumetric heat capacity of soil; Lᵢ denotes a latent heat value for water freezing; S denotes saturation of soil; Lᵥ denotes a latent heat value for water vaporization; Cₗ denotes a volumetric heat capacity of liquid water; qₗ denotes a liquid water flux in soil; Cᵥ denotes a volumetric heat capacity of vapor; and qᵥ denotes a vapor flux.

In a further embodiment, the material property parameters include a hydrothermal physical parameter of the subgrade and a soil layer, and a thermal physical parameter of polyurethane.

The hydrothermal physical parameter of the subgrade and the soil layer include a dry density, a specific heat capacity of a thawed soil, a specific heat capacity of a frozen soil, a heat transfer coefficient of the thawed soil, a heat transfer coefficient of the frozen soil, a porosity, a saturated water content, and a residual water content.

The thermal physical parameter of the polyurethane includes a dry density of the polyurethane, a heat transfer coefficient of the polyurethane, and a specific heat capacity of the polyurethane.

In a further embodiment, the temperature and water boundary condition include a top temperature boundary condition, a bottom heat flux boundary condition, a side adiabatic boundary condition, and a circumambient zero flux water boundary condition of the subgrade water-vapor-heat coupling geometric model, where the top temperature boundary condition includes a thermal boundary condition of a top surface of the subgrade, a thermal boundary condition of a side slope of the subgrade, and a thermal boundary condition of a natural surface.

The top temperature boundary condition is in the form of a sinusoidal function which is specifically as follows:

$$R = {T}_{a} + \frac{k}{365} {t}_{a} + A sin ( \frac{2 π}{365} {t}_{a} + φ ) .$$

In the above equation, R denotes a temperature varying with the sinusoidal function; Ta denotes an annual average shallow soil temperature; k denotes an annual warming rate; ta denotes time in days; A denotes an annual shallow soil temperature amplitude; and tp denotes an initial phase of soil.

In a further embodiment, the step where mesh generation is performed on the subgrade water-vapor-heat coupling geometric model by using mapping and a free triangular mesh and mesh encryption is performed on a polyurethane thermal insulation layer and a surrounding region of the polyurethane thermal insulation layer to obtain a meshing model includes the following steps.

With minimizing a mesh global error of the subgrade water-vapor-heat coupling geometric model as a goal, global mesh iterative refinement is performed on the subgrade water-vapor-heat coupling geometric model multiple times to obtain a globally optimized mesh.

A subgrade water state-based integral along a subgrade boundary is defined as a water state boundary error index according to a subgrade water state spatial distribution data of the subgrade water-vapor-heat coupling geometric model.

A water-vapor-heat coupling key feature region is identified from the globally optimized mesh by using the water state boundary error index and according to a geometric feature of the subgrade water-vapor-heat coupling geometric model, the temperature boundary condition, and the water boundary condition.

An intra-mesh physical field coupling effect is quantified according to water migration and heat exchange on a boundary of the water-vapor-heat coupling key feature region, and a multi-physical field coupling effect evaluation matrix is constructed by using a Gaussian integral.

Local adaptive mesh generation is performed on the globally optimized mesh by using the water state boundary error index and according to the multi-physical field coupling effect evaluation matrix to obtain a locally optimized mesh.

The locally optimized mesh is mapped to the different material layers of the subgrade water-vapor-heat coupling geometric model by using a mapping method, and mesh refinement is performed on the different material layers by using a free triangle mesh generation method and according to physical properties of the different material layers in the subgrade water-vapor-heat coupling geometric model to obtain a layered mesh model, where the material layers include a double-layer polyurethane thermal insulation layer and a subgrade material layer.

The mesh encryption is performed on a water-vapor-heat coupling key feature region in the layered mesh model according to a predetermined scaling ratio to obtain the meshing model.

In a further embodiment, a water-vapor-heat coupling simulation solution is performed on the meshing model by using a transient solver.

In a second aspect, the present disclosure provides a grouting subgrade water-vapor-heat coupling simulation system. The system includes a geometric model construction module, a model coupling analysis module, a model condition determination module, a model meshing module, a model coupling stimulation module, and a subgrade property analysis module.

The geometric model construction module is configured to construct a two-dimensional axisymmetric subgrade water-vapor-heat coupling geometric model according to a physical size and a position parameter of a subgrade and a physical size and a position parameter of a double-layer polyurethane grouting thermal insulation structure.

The model coupling analysis module is configured to acquire a partial differential equation of a subgrade water-vapor-heat coupling process and establish a relationship between physical fields.

The model condition determination module is configured to define material property parameters of different material layers in the subgrade water-vapor-heat coupling geometric model and set a temperature and water boundary condition in the subgrade water-vapor-heat coupling geometric model.

The model meshing module is configured to perform mesh generation on the subgrade water-vapor-heat coupling geometric model by using mapping and a free triangular mesh and perform mesh encryption on a polyurethane thermal insulation layer and a surrounding region of the polyurethane thermal insulation layer to obtain a meshing model.

The model coupling stimulation module is configured to select soil temperatures and unfrozen water contents at different depths as initial data and perform a simulation solution on the meshing model to obtain a water-vapor-heat coupling simulation result.

The subgrade property analysis module is configured to analyze the impact of the double-layer polyurethane grouting thermal insulation structure on a temperature distribution, a freeze-thaw cycle depth, and water migration of the subgrade according to the water-vapor-heat coupling simulation result.

In a third aspect, the present disclosure further provides a computer device. The computer device includes a processor and a memory. The processor is connected to the memory. The memory is used for storing a computer program, and the processor is used for executing the computer program stored in the memory to cause the computer device to perform the steps of the method described above.

In a fourth aspect, the present disclosure further provides a non-transitory computer-readable storage medium. The non-transitory computer-readable storage medium is used for storing a computer program. When the computer program is executed by a processor, the steps of the method described above are performed.

The present disclosure provides a grouting subgrade water-vapor-heat coupling simulation method and system, a device and a medium. The method includes the following steps: a two-dimensional axisymmetric subgrade water-vapor-heat coupling geometric model is constructed according to a physical size and a position parameter of a subgrade and a physical size and a position parameter of a double-layer polyurethane grouting thermal insulation structure; a partial differential equation of a subgrade water-vapor-heat coupling process is acquired, and a relationship between physical fields is established; material property parameters of different material layers in the subgrade water-vapor-heat coupling geometric model are defined, and a temperature and water boundary condition is set in the subgrade water-vapor-heat coupling geometric model; mesh generation is performed on the subgrade water-vapor-heat coupling geometric model by using mapping and a free triangular mesh, and mesh encryption is performed on a polyurethane thermal insulation layer and a surrounding region of the polyurethane thermal insulation layer to obtain a meshing model; soil temperatures and unfrozen water contents at different depths are selected as initial data, and a simulation solution is performed on the meshing model to obtain a water-vapor-heat coupling simulation result; and the impact of the double-layer polyurethane grouting thermal insulation structure on a temperature distribution, a freeze-thaw cycle depth, and water migration of the subgrade is analyzed according to the water-vapor-heat coupling simulation result. Compared with the existing art, the method simulates and quantitatively analyzes the impact of a polyurethane layer on the temperature profile, the freeze-thaw depth, and the water distribution of a subgrade with the factors such as temperature changes, water migration, and thermal insulation layer performance in subgrade engineering in an alpine region into comprehensive consideration, thereby providing a scientific basis and a technical support for thermal insulation designs in subgrade engineering in permafrost region and improving the stability and durability in subgrade engineering.

### BRIEF DESCRIPTION OF DRAWINGS

FIG. 1 is a flowchart of a grouting subgrade water-vapor-heat coupling simulation method according to an embodiment of the present disclosure;

FIG. 2 is a schematic diagram of mesh generation on a subgrade water-vapor-heat coupling geometric model according to an embodiment of the present disclosure;

FIG. 3 is a schematic diagram of a temperature contour of a grouting subgrade in winter according to an embodiment of the present disclosure;

FIG. 4 is a schematic diagram of a temperature contour of a natural subgrade in winter according to an embodiment of the present disclosure;

FIG. 5 is a schematic diagram of a temperature contour of the grouting subgrade in summer according to an embodiment of the present disclosure;

FIG. 6 is a schematic diagram of a temperature contour of the natural subgrade in summer according to an embodiment of the present disclosure;

FIG. 7 is a schematic diagram of a water content contour of the grouting subgrade in winter according to an embodiment of the present disclosure;

FIG. 8 is a schematic diagram of a water content contour of the grouting subgrade in summer according to an embodiment of the present disclosure;

FIG. 9 is a schematic diagram of the impact of a temperature on vapor migration and a liquid water flow according to an embodiment of the present disclosure;

FIG. 10 is a block diagram of a grouting subgrade water-vapor-heat coupling simulation system according to an embodiment of the present disclosure; and

FIG. 11 is a structure diagram of a computer device according to an embodiment of the present disclosure.

### DETAILED DESCRIPTION

Embodiments of the present disclosure will be described in detail in conjunction with the drawings. The embodiments are given solely for the purpose of illustration and are not to be construed as limitations of the present disclosure, and in addition, the drawings are also used for reference and illustration only and do not constitute limitations on the scope of the present disclosure, as many variations may be made to the present disclosure without departing from the spirit and scope of the present disclosure.

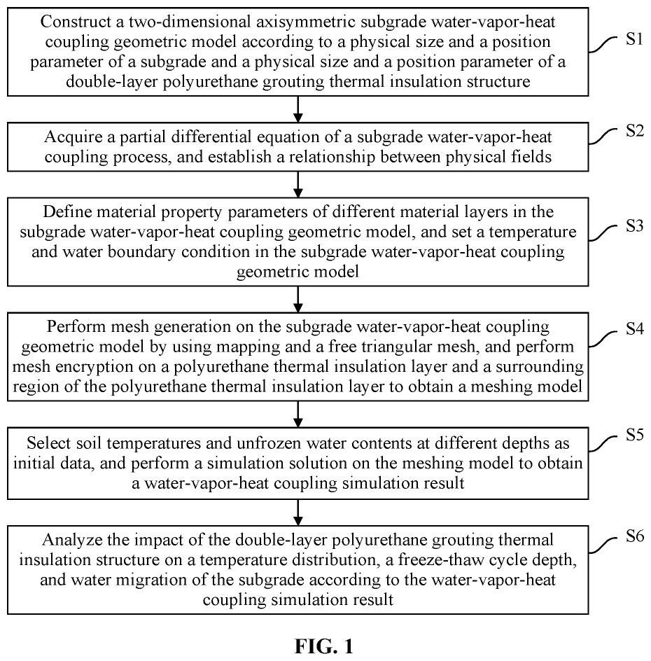

With reference to FIG. 1, the embodiments of the present disclosure provide a grouting subgrade water-vapor-heat coupling simulation method. As shown in FIG. 1, the method includes steps S1 to S6.

In S1, a two-dimensional axisymmetric subgrade water-vapor-heat coupling geometric model is constructed according to a physical size and a position parameter of a subgrade and a physical size and a position parameter of a double-layer polyurethane grouting thermal insulation structure.

In the embodiments, a whole hydrothermal change process is analyzed by analyzing the vertical section of a subgrade, and the structure of the subgrade is constructed into a two-dimensional axisymmetric subgrade water-vapor-heat coupling geometric model according to a physical size and a position parameter of the subgrade and a physical size and a position parameter of a double-layer polyurethane grouting thermal insulation structure to observe and analyze the hydrothermal change process. Specifically, the subgrade water-vapor-heat coupling geometric model mainly includes a subgrade layer which includes a subgrade, a side slope, a soil layer, and a polyurethane thermal insulation layer and has a 2.5-meter-thick top. The subgrade layer is mainly constructed of crushed stones and gravels and is designed to have two levels of side slopes. The first-level side slope has a gradient of 1:1 and a height of 1.5 meters (m), and the second-level side slope has a gradient of 1:0.8 and a height of 1 m. The middle of the subgrade layer is a 5.5-meter-thick gravel layer. In the embodiments, the top of the subgrade is designed with a width of 3 m, and the bottom of the subgrade is designed with a width of 7.3 m to ensure stability.

To improve the thermal insulation effect, double-layer polyurethane thermal insulation layers with rectangular geometries are drawn at 0.75 m and 1.5 m from the top of the subgrade and on the two levels of side slopes of the subgrade, respectively, and the thickness of these thermal insulation layers is 0.01 m. These thermal insulation layers can effectively reduce heat dissipation and keep the temperature of the subgrade stable. In the deeper strata, the interval from −5.5 m to 0 m is divided into the gravel layer, the interval from −10 m to −5.5 m is composed of a strongly-weathered mudstone layer, and the total width of each of the two regions reaches 17.3 m. This layered design helps to simulate and analyze the impact of different strata on the stability of the subgrade, thereby providing important reference data for practical engineering.

In S2, a partial differential equation of a subgrade water-vapor-heat coupling process is acquired, and a relationship between physical fields is established.

The partial differential equation adopted in the embodiments achieves the direct coupling simulation of water, vapor, and heat energy transfer processes and integrates three key variables, including a volume content θₗ of water (liquid water), a volume content θᵢ of ice (solid ice), and a volume content θᵥ of vapor, in the conventional water parabolic partial differential equation into a single variable, that is, into saturation S of a soil mass. Such a simplification strategy improves the convergence of the numerical model, ensures the stability and the efficiency of the calculation process, and enriches the ability of the model to capture actual physical phenomena. Specifically, in the embodiments, by adopting the single variable, the saturation S of the soil mass, the dynamic change of the water field inside the subgrade driven by vapor migration (including evaporation, condensation, diffusion, and the like) can be comprehensively and continuously simulated. This property is of great importance for predicting the physical state evolution of subgrade materials, the decay of thermal insulation performance, and the potential risk of water damage under different climatic conditions and road usage conditions.

Specifically, in the embodiments, the partial differential equation (PDE) module in simulation software is adopted to simulate physical processes such as heat conduction, water migration, and vapor diffusion, and the required partial differential equation and the relationship between physical fields are defined to simulate the multi-field coupling effects in the subgrade and the double-layer polyurethane thermal insulation structure. In the embodiments, the partial differential equation includes a water parabolic partial differential equation and a heat conduction parabolic partial differential equation. The water parabolic partial differential equation is specifically as follows:

$${d}_{w} \frac{\partial S}{\partial t} + ∇ * {γ}_{w} + aS = {f}_{w}$$

$$where$$

$${d}_{w} = ( {θ}_{s} - {θ}_{r} ) [ 1 + \frac{{ρ}_{i}}{{ρ}_{l}} {B}_{i} ( T ) - \frac{{ρ}_{v}}{{ρ}_{l}} {B}_{i} ( T ) - \frac{{ρ}_{v}}{{ρ}_{l}} ]$$

$${γ}_{w} = - [ {K}_{lh} ∇ ( {h}_{m} + y ) + {K}_{lT} ∇ T ] - \frac{{ρ}_{v}}{{ρ}_{l}} [ {K}_{vh} ∇ {h}_{m} + {K}_{vT} ∇ T ]$$

$$a = ( \frac{{ρ}_{i}}{{ρ}_{l}} - \frac{{ρ}_{v}}{{ρ}_{l}} ) ( {θ}_{s} - {θ}_{r} ) \frac{\partial B}{\partial T} * \frac{\partial T}{\partial t}$$

$${f}_{w} = - [ ( \frac{{ρ}_{i}}{{ρ}_{l}} - \frac{{ρ}_{v}}{{ρ}_{l}} ) * {θ}_{r} * \frac{\partial B}{\partial T} * \frac{\partial T}{\partial t} ]$$

$${B}_{i} ( T ) = \frac{{θ}_{i}}{{θ}_{l}} = \{ \begin{matrix}1.1 {( \frac{T}{{T}_{f}} )}^{B} - 1 & T < {T}_{f} \\ 0 & T \geq {T}_{f}\end{matrix}$$

In the above equation, d_{w} denotes a damping coefficient of a water coefficient partial differential equation; S denotes saturation of soil; t denotes time in seconds; γ_{w} denotes a conservation flux source item of the water coefficient partial differential equation; α denotes a conservation flux convection coefficient; f_{w} denotes a source item of the water coefficient partial differential equation; θₛ denotes a saturated water content of the soil mass; θᵣ denotes a residual water content of the soil mass; ρᵢ denotes a density of ice; ρₗ denotes a density of liquid water; Bᵢ(T) denotes the ratio of a pore ice volume to an unfrozen water volume; ρᵥ denotes a density of vapor; Kₗₕ denotes an isothermal hydraulic conductivity derivative; ∇ denotes a Laplace operator and is defined as

$$∇ = \frac{\partial }{\partial x} + \frac{\partial }{\partial y} ;$$

hₘ denotes a pressure head; x denotes an abscissa of spatial coordinates of the soil mass; y denotes an ordinate of spatial coordinates of the soil mass; K_{lT} denotes a non-isothermal hydraulic conductivity derivative; T denotes a temperature; Kᵥₕ denotes an isothermal vapor hydraulic conductivity; K_{vT} denotes a non-isothermal vapor hydraulic conductivity; θᵢ denotes a volume content of ice in soil; θₗ denotes a volume content of unfrozen water in soil; T_{f} denotes a freezing temperature; and B denotes an empirical constant, where the empirical constant of sandy soil is 0.61, the empirical constant of silt is 0.47, and the empirical constant of clay is 0.56.

The heat conduction parabolic partial differential equation is specifically as follows:

$${d}_{h} \frac{\partial T}{\partial t} + ∇ * ( - λ ∇ T - α T + {γ}_{h} ) = {f}_{h}$$

$$where$$

$${d}_{h} = \{ C - {L}_{i} {ρ}_{i} [ S ( {θ}_{s} - {θ}_{r} ) + {θ}_{r} ] \frac{\partial B}{\partial T} - {L}_{v} {ρ}_{v} [ S ( {θ}_{s} - {θ}_{r} ) + {θ}_{r} ] \frac{\partial B}{\partial T} \}$$

$$α = {C}_{l} {q}_{l} + {C}_{v} {q}_{v}$$

$${γ}_{h} = {L}_{v} {ρ}_{v} ∇ {q}_{v}$$

$${f}_{h} = ( {L}_{i} {ρ}_{i} B + {L}_{v} {ρ}_{v} B + {L}_{v} {ρ}_{v} ) [ ( {θ}_{s} - {θ}_{r} ) \frac{\partial S}{\partial t} ] .$$

In the above equation, dₕ denotes a damping coefficient of a heat conduction coefficient partial differential equation; λ denotes a heat transfer coefficient of soil, in W·m⁻¹. K⁻¹; α denotes an absorption coefficient; γₕ denotes a conservation flux source item of the heat conduction coefficient partial differential equation; fₕ denotes a source item of the heat conduction coefficient partial differential equation; C denotes a volumetric heat capacity of soil, in J·m⁻³·K⁻¹; Lᵢ denotes a latent heat value for water freezing, in kJ·kg⁻¹; S denotes saturation of soil; Lᵥ denotes a latent heat value for water vaporization, in kJ·kg⁻¹; Cₗ denotes a volumetric heat capacity of liquid water, in J·m⁻³·K⁻¹; qₗ denotes a liquid water flux in soil; Cᵥ denotes a volumetric heat capacity of vapor, in J·m⁻³·K⁻¹; and qᵥ denotes a vapor flux, in m·s⁻¹.

To facilitate the understanding of the partial differential equation of the subgrade water-vapor-heat coupling process, in the embodiments, the process of achieving the partial differential equation of the subgrade water-vapor-heat coupling process will be explained in detail below. Firstly, the partial differential equation of a water-vapor-heat coupling behavior in an unsaturated soil is defined. In the embodiments, an unsaturated soil water-vapor-heat coupling control equation is constructed based on a defined water mass conservation equation for liquid water migration, vapor water migration, and ice content in the unsaturated soil and with a heat transfer equation of an ice-water-vapor phase transition effect during the freeze-thaw process of the soil mass taken into consideration to simulate the complex physical process of the subgrade under the action of water-vapor-heat coupling, where the water mass conservation equation for liquid water migration, vapor water migration, and ice content in the unsaturated soil is as follows:

$$\frac{\partial {θ}_{l}}{\partial t} + \frac{{ρ}_{v}}{{ρ}_{l}} \frac{\partial {θ}_{v}}{\partial t} + \frac{{ρ}_{v}}{{ρ}_{l}} \frac{\partial {θ}_{i}}{\partial t} = ∇ * [ {K}_{lh} ∇ ( {h}_{m} + z ) + {K}_{lT} ∇ T ] + \frac{{ρ}_{v}}{{ρ}_{l}} ∇ [ {K}_{vh} ∇ {h}_{m} + {K}_{vT} ∇ T ] .$$

In the above equation, θₗ denotes a volume content of liquid water; t denotes the time in seconds; T denotes a temperature in ° C.; ρᵥ denotes the density of vapor; ρₗ denotes the density of liquid water; θᵥ denotes a volume content of vapor, in m³·m⁻³; ρᵢ denotes the density of ice, in kg·m⁻³; θᵢ denotes a volume content of ice, in m³·m⁻³; Kₗₕ denotes the isothermal hydraulic conductivity derivative, in m·s⁻¹; K_{lT} denotes the non-isothermal hydraulic conductivity derivative, in m²·K⁻¹·s⁻¹; Kᵥₕ denotes the isothermal vapor hydraulic conductivity, in m·s⁻¹; and K_{vT} denotes the non-isothermal vapor hydraulic conductivity, in m²·K⁻¹·s⁻¹.

When the ice-water-vapor phase transition effect during the freeze-thaw process of the soil mass is considered by using Fourier's law and the law of conservation of energy, the corresponding heat transfer equation may be expressed as:

$$C \frac{\partial T}{\partial t} - {L}_{i} {ρ}_{i} \frac{\partial {θ}_{i}}{\partial t} + {L}_{v} {ρ}_{v} \frac{\partial {θ}_{v}}{\partial t} = ∇ [ λ ∇ T ] - [ {C}_{l} ∇ ( {q}_{l} T ) ] - [ {C}_{v} ∇ ( {q}_{v} T ) ] - {L}_{v} {ρ}_{v} ∇ {q}_{v} .$$

Then, the above water mass conservation equation and the heat transfer equation are converted into the form of a standard coefficient partial differential equation of the simulation software to make the water mass conservation equation and the heat transfer equation meet the requirements of a PDE solver of a mathematical module in the simulation software. In the embodiments, the coefficients in the converted coefficient partial differential equation may be assigned values according to a physical model and the requirements of actual problems to obtain partial differential equations with various properties. These coefficients include a mass coefficient, a damping coefficient, a diffusion coefficient, an absorption coefficient, a convection coefficient, a conservation flux convection coefficient, a conservation flux source item, and a source term, and the values of these coefficients depend on the physical properties of a material and the characteristics of a process. After the coefficients in the equation are assigned values, a numerical solution method is set. In the embodiments, a time term in the equation is discretized by using an implicit Euler backward differentiation formula, and the equation is solved by using a nonlinear iterative modified damped Newton's method. The form of the standard coefficient partial differential equation is as follows:

$${e}_{a} \frac{{\partial }^{2} u}{\partial {t}^{2}} + {d}_{a} \frac{\partial u}{\partial t} + ∇ \cdot ( - c ∇ u - α u + γ ) + β \cdot ∇ u + a u = f .$$

In the above equation, u denotes a solution variable; e_{α} denotes the mass coefficient; d_{α} denotes the damping coefficient; c is the diffusion coefficient; α denotes the absorption coefficient; β denotes the convection coefficient; α denotes the conservation flux convection coefficient; γ denotes the conservation flux source item; and f denotes the source item.

It is to be noted that the conversion process of converting the unsaturated soil water-vapor-heat coupling control equation into the parabolic partial differential equations with a temperature and a relative saturation as variables will be explained in detail through a series of derivation processes in the embodiments. The process of converting and transforming the unsaturated soil water-vapor-heat coupling control equation into the form of the standard coefficient partial differential equation in the simulation software through the transposition of terms is as follows.

In the embodiments, an effective saturation is defined, and a relationship function between an unfrozen water content and a temperature is derived based on the freezing temperature of the soil mass, an initial water content of the soil mass, and the empirical constant. When the freeze-thaw effect is taken into consideration, the water in a frozen soil includes ice, liquid water, and vapor water, and the volume content of water in the frozen soil may be expressed as:

$${θ}_{l} + {θ}_{i} + {θ}_{v} = n .$$

In the above equation, θ denotes a volume content of water in the frozen soil; n denotes a porosity; θₗ denotes the volume content of liquid water; θᵥ denotes the volume content of vapor; and θᵢ denotes the volume content of ice.

To facilitate the following mathematical derivation process, the effective saturation of the frozen soil may be defined as:

$${S}_{e} = \frac{{θ}_{l} - {θ}_{r}}{{θ}_{s} - {θ}_{r}} .$$

In the above equation, θᵣ denotes the residual water content of the soil mass; θₛ denotes the saturated water content of the soil mass; and Sₑ denotes the effective saturation of the frozen soil.

The relationship function between the unfrozen water content and the temperature during the freezing of soil is as follows:

$$\frac{{w}_{0}}{{w}_{l}} = {( \frac{T}{{T}_{f}} )}^{B}$$

$$T < {T}_{f} .$$

In the above equation, w₀ denotes the initial water content (%) of the soil mass; wₗ denotes an unfrozen water content (%) at a negative temperature of T; T_{f} denotes the freezing temperature (° C.) of the soil mass; and B denotes the empirical constant, where generally, the empirical constant of sandy soil is 0.61, the empirical constant of silt is 0.47, and the empirical constant of clay is 0.56.

In the embodiments, the ratio of the pore ice volume to the unfrozen water volume is derived based on the relationship function between the unfrozen water content and the temperature and defined as a solid-liquid ratio. The following equation is then derived:

$${B}_{i} = \frac{{θ}_{i}}{{θ}_{l}} = \{ \begin{matrix}1.1 {( \frac{T}{{T}_{f}} )}^{B} - 1 & ( T < {T}_{f} ) \\ 0 & ( T \geq {T}_{f} ) .\end{matrix}$$

In the above equation, Bᵢ denotes the solid-liquid ratio, and the coefficient of 1.1 is the ratio of the density of water to the density of ice.

As can be seen, the solid-liquid ratio is a single-valued function of the temperature, so in the embodiments, a relationship equation between the pore ice, the unfrozen water, and the temperature in the frozen soil is derived by using the solid-liquid ratio and the effective saturation. The relationship equation between the pore ice, the unfrozen water, and the temperature in the frozen soil is as follows:

$${θ}_{i} = {B}_{i} ( T ) \cdot {θ}_{l} .$$

The derivative of the relationship equation between the pore ice, the unfrozen water, and the temperature in the frozen soil with respect to time yields a rate of change of the pore ice and the unfrozen water with time. Accordingly, a first equation may be obtained:

$$\frac{\partial {θ}_{i}}{\partial t} = \frac{\partial {θ}_{l}}{\partial t} {B}_{i} ( T ) + \frac{\partial {B}_{i} ( T )}{\partial t} {θ}_{l} .$$

Based on the calculation formula of the effective saturation of the frozen soil, a second equation may be obtained:

$${θ}_{l} = S ( {θ}_{s} - {θ}_{r} ) + {θ}_{r} .$$

The derivative of the second equation with respect to time may yield a third equation:

$$\frac{\partial {θ}_{l}}{\partial t} = ( {θ}_{s} - {θ}_{r} ) \frac{\partial S}{\partial t} .$$

Based on the first and third equations, a fourth equation may be obtained:

$$\frac{\partial {θ}_{i}}{\partial t} = {B}_{i} ( T ) \cdot ( {θ}_{s} - {θ}_{r} ) \frac{\partial S}{\partial t} + [ S ( {θ}_{s} - {θ}_{r} ) + {θ}_{r} ] \cdot \frac{\partial {B}_{i} ( T )}{\partial t} .$$

Similarly, based on the third and fourth equations, a fifth equation may be obtained:

$$\frac{\partial {θ}_{v}}{\partial t} = - \{ {B}_{i} ( T ) \cdot ( {θ}_{s} - {θ}_{r} ) \frac{\partial S}{\partial t} + [ S ( {θ}_{s} - {θ}_{r} ) + {θ}_{r} ] \cdot \frac{\partial {B}_{i} ( T )}{\partial t} \} - ( {θ}_{s} - {θ}_{r} ) \frac{\partial S}{\partial t} .$$

A mathematical calculation is performed by substituting the fourth and fifth equations into the water mass conservation equation for liquid water migration, vapor water migration, and ice content in the unsaturated soil and taking the relative saturation as a field function, and the parabolic partial differential equation with the relative saturation as the variable is constructed:

$$[ 1 + \frac{{ρ}_{i}}{{ρ}_{l}} {B}_{i} ( T ) - \frac{{ρ}_{v}}{{ρ}_{l}} {B}_{i} ( T ) - \frac{{ρ}_{v}}{{ρ}_{l}} ] [ ( {θ}_{s} - {θ}_{r} ) \frac{\partial S}{\partial t} ] - ∇ \cdot [ {K}_{lh} ∇ ( {h}_{m} + z ) + {K}_{lT} ∇ T ] - \frac{{ρ}_{v}}{{ρ}_{l}} ∇ \cdot [ {K}_{vh} ∇ {h}_{m} + {K}_{vT} ∇ T ] + ( \frac{{ρ}_{i}}{{ρ}_{l}} - \frac{{ρ}_{v}}{{ρ}_{l}} ) \{ [ S ( {θ}_{s} - {θ}_{r} ) + {θ}_{r} ] \frac{\partial B}{\partial T} \cdot \frac{\partial T}{\partial t} \} = 0.$$

A mathematical calculation is performed by substituting the fourth and fifth equations into the heat transfer equation of the ice-water-vapor phase transition effect during the freeze-thaw process of the soil mass and with the temperature as a field function, and the parabolic partial differential equation with the temperature as the variable is constructed:

$$( C - {L}_{i} {ρ}_{i} [ S ( {θ}_{s} - {θ}_{r} ) + {θ}_{r} ] \frac{\partial B}{\partial T} - {L}_{v} {ρ}_{v} [ S ( {θ}_{s} - {θ}_{r} ) + {θ}_{r} ] \frac{\partial B}{\partial T} ) \frac{\partial T}{\partial t} + ∇ ( - λ ∇ T + [ {C}_{l} ∇ ( {q}_{l} T ) ] + [ {C}_{v} ∇ ( {q}_{v} T ) ] + {L}_{v} {ρ}_{v} ∇ {q}_{v} ) = ( {L}_{i} {ρ}_{i} B + {L}_{v} {ρ}_{v} B + {L}_{v} {ρ}_{v} ) [ ( {θ}_{s} - {θ}_{r} ) \frac{\partial S}{\partial t} ] .$$

In the embodiments, the time term is discretized by using the implicit Euler backward differentiation formula, a solution is performed by using the nonlinear iterative modified damped Newton's method, and then the parabolic partial differential equations with the temperature and the relative saturation as the variables are constructed to simulate the water-vapor-heat coupling process in the unsaturated soil, thereby enabling the simulation results to comprehensively reflect the changes in the temperature, the humidity, and the ice content of the subgrade in different seasons and under different climatic conditions.

In S3, material property parameters of different material layers in the subgrade water-vapor-heat coupling geometric model are defined, and a temperature and water boundary condition is set in the subgrade water-vapor-heat coupling geometric model.

In the embodiments, the temperature boundary condition and a water boundary condition both adopt the Dirichlet boundary condition. For a partial differential equation,

$${∇}^{2} y + y = 0$$

where ∇² denotes the Laplace operator, the Dirichlet boundary conditions on a domain Ω⊂Rⁿ take the form:

$$y ( x ) = f ( x ) , ∀ x ∈ \partial Ω .$$

It is more flexible to set the boundary condition by using the Dirichlet boundary condition in numerical software, thereby satisfying the boundary conditions that match the actual situation.

In the embodiments, the material property parameters of the different material layers in the subgrade water-vapor-heat coupling geometric model can be determined according to the coefficients that need to be assigned values. The material property parameters include a hydrothermal physical parameter of the subgrade and the soil layer, and a thermal physical parameter of polyurethane. As shown in Table 1, the hydrothermal physical parameter of the subgrade and the soil layer includes a dry density ρ_{d}, a specific heat capacity Cᵤ of a thawed soil, a specific heat capacity C_{f} of the frozen soil, a heat transfer coefficient λᵤ of the thawed soil, a heat transfer coefficient λ_{f} of the frozen soil, a porosity n, a saturated water content θₛ, and a residual water content θᵣ. It is to be noted that Table 1 shows exemplary values of the hydrothermal physical parameter of the subgrade and the soil layer.

TABLE 1

| | | | | Strongly- |
|---|---|---|---|---|
| | | Crushed stones | | weathered |
| Parameter | Unit | and gravels | gravels | mudstones |
| ρ_{d} | kg · m⁻³ | 2184 | 1920 | 2310 |
| Cᵤ | J · kg⁻¹ · K⁻¹ | 1019.88 | 1511.98 | 908.66 |
| C_{f} | J · kg⁻¹ · K⁻¹ | 876.08 | 1174.48 | 799.13 |
| λᵤ | W · m⁻¹ · K⁻¹ | 1.919 | 1.856 | 1.474 |
| λ_{f} | W · m⁻¹ · K⁻¹ | 1.980 | 2.659 | 1.824 |
| n | 1 | 0.28 | 0.45 | 0.18 |
| θₛ | m³ · m⁻³ | 0.44 | 0.57 | 0.5 |
| θᵣ | m³ · m⁻³ | 0.01 | 0.02 | 0.01 |

The thermal physical parameter of the polyurethane includes a dry density ρ_{d}, of the polyurethane, a heat transfer coefficient λₚ of the polyurethane, and a specific heat capacity Cₚ of the polyurethane. Table 2 shows the exemplary thermal physical parameter of the polyurethane.

TABLE 2

| Parameter | ρ_{d}_{ₚ} (kg · m⁻³) | λₚ (W · m⁻¹ · K⁻¹) | Cₚ (J · kg⁻¹ · K⁻¹) |
|---|---|---|---|
| PU | 150 | 0.018 | 1500 |

Then, in the embodiments, the Dirichlet boundary condition is selected to define the temperature boundary condition. The temperature boundary condition includes a top temperature boundary condition, a bottom heat flux boundary condition, a side adiabatic boundary condition, and a circumambient zero flux water boundary condition of the top surface of the subgrade, a top temperature boundary condition, a bottom heat flux boundary condition, a side adiabatic boundary condition, and a circumambient zero flux water boundary condition of the side slope of the subgrade, a top temperature boundary condition, a bottom heat flux boundary condition, a side adiabatic boundary condition, and a circumambient zero flux water boundary condition of a natural surface, where the heat flux of the bottom heat flux boundary condition is 0.06 W·m⁻². Furthermore, in the embodiments, the temperature boundary condition is defined in the form of a sinusoidal function, the difference between the temperature boundary conditions of the sunny slope and the shady slopes is omitted, and an annual shallow soil temperature amplitude of the top surface of the subgrade, an annual shallow soil temperature amplitude of the side slope of the subgrade, an annual shallow soil temperature amplitude of the natural surface, and an initial phase of soil are obtained by fitting. The temperature boundary condition in the form of a sinusoidal function is expressed as:

$$R = {T}_{a} + \frac{k}{365} {t}_{a} + A sin ( \frac{2 π}{365} {t}_{a} + φ ) .$$

In the above equation, R denotes a temperature varying with the sinusoidal function; T_{α} denotes an annual average shallow soil temperature; k denotes an annual warming rate; t_{α} denotes time (d) in days; A denotes the annual shallow soil temperature amplitude; and φ denotes the initial phase of soil.

In S4, mesh generation is performed on the subgrade water-vapor-heat coupling geometric model by using mapping and a free triangular mesh, and mesh encryption is performed on a polyurethane thermal insulation layer and a surrounding region of the polyurethane thermal insulation layer to obtain a meshing model.

In the embodiments, the step where mesh generation is performed on the subgrade water-vapor-heat coupling geometric model by using mapping and a free triangular mesh and mesh encryption is performed on a polyurethane thermal insulation layer and a surrounding region of the polyurethane thermal insulation layer to obtain a meshing model includes the following steps.

With minimizing a mesh global error of the subgrade water-vapor-heat coupling geometric model as a goal, global mesh iterative refinement is performed on the subgrade water-vapor-heat coupling geometric model multiple times to obtain a globally optimized mesh.

A subgrade water state-based integral along a subgrade boundary is defined as a water state boundary error index according to a subgrade water state spatial distribution data of the subgrade water-vapor-heat coupling geometric model.

A water-vapor-heat coupling key feature region is identified from the globally optimized mesh by using the water state boundary error index and according to a geometric feature of the subgrade water-vapor-heat coupling geometric model, the temperature boundary condition, and the water boundary condition.

An intra-mesh physical field coupling effect is quantified according to water migration and heat exchange on a boundary of the water-vapor-heat coupling key feature region, and a multi-physical field coupling effect evaluation matrix is constructed by using a Gaussian integral.

Local adaptive mesh generation is performed on the globally optimized mesh by using the water state boundary error index and according to the multi-physical field coupling effect evaluation matrix to obtain a locally optimized mesh.

The locally optimized mesh is mapped to the different material layers of the subgrade water-vapor-heat coupling geometric model by using a mapping method and according to the geometric feature of the subgrade water-vapor-heat coupling geometric model and physical properties of the different material layers, and mesh refinement is performed on the different material layers by using a free triangle mesh generation method and according to the physical properties of the different material layers in the subgrade water-vapor-heat coupling geometric model to obtain a layered mesh model, where the material layers include a double-layer polyurethane thermal insulation layer and a subgrade material layer.

The mesh encryption is performed on a water-vapor-heat coupling key feature region in the layered mesh model according to a predetermined scaling ratio to obtain the meshing model, where the water-vapor-heat coupling key feature region includes the polyurethane thermal insulation layer, the surrounding region of the polyurethane thermal insulation layer, and a region having a high water content or a drastic heat change.

Specifically, in the embodiments, global mesh refinement is performed on the subgrade water-vapor-heat coupling geometric model at an initial stage to ensure that the error within the entire range of the model is effectively controlled. For example, global mesh iterative refinement is performed on the subgrade water-vapor-heat coupling geometric model multiple times by calculating an L2 norm error estimation between the mesh solutions of the model to refine a region that needs small cells, coarsen a region that does not requires fine meshes, and perform mesh coarsening on a region having lower error requirements, thereby balancing the error distribution of the subgrade water-vapor-heat coupling geometric model. In the above process, iterative refinement may be performed four times in the embodiments to gradually improve the precision of the model, and each iteration is performed based on the results of the previous iteration to further optimize the mesh generation. To further improve the simulation precision, especially the simulation precision in a region having a complex water-vapor-heat coupling effect in the subgrade having the double-layer polyurethane grouting thermal insulation structure, a local adaptive mesh generation technique is further adopted on the basis of the global mesh refinement in the embodiments. In this process, since the water state in the subgrade has an important impact on the water-vapor-heat coupling process, in the embodiments, a water state (for example, a volumetric water content) of the subgrade is selected as a model variable, and an integral value of the model variable along the boundary of the subgrade is calculated by using a trapezoidal method or a Simpson's method to form a water state boundary error index for guiding the mesh refinement in the key feature region during the water-vapor-heat coupling process. The water state boundary error index can quantify the water distribution on the boundary and is used for assessing the mesh refinement requirements of different regions. In the embodiments, by assessing the error of each mesh region in the model according to the water state boundary error index, a region which has a significant impact on the water-vapor-heat coupling can be automatically identified, such as a region with water accumulation, vapor infiltration or an active heat exchange, a water inflow/outflow point, and a region having a drastic temperature change. In the embodiments, the coupling effect of water migration and a heat exchange on the boundary on the intra-mesh physical fields is quantified according to the volumetric water content distribution of each point on the boundary of the water-vapor-heat coupling key feature region, the temperature boundary condition, and the water boundary condition. A multi-physical field coupling effect assessment matrix is constructed by using a Gaussian integral, and the multi-physical field coupling effect assessment matrix is used to guide the local mesh refinement. In the process of the local adaptive mesh generation, the error of each region (such as the region having a high water content or a drastic heat change) in the model is assessed by using the water state boundary error index, thereby achieving the gradual optimization of the mesh generation from the global level to the local level. Furthermore, in conjunction with the physical properties of the different material layers such as a thermal conductivity and a water migration property as well as the key feature region during the water-vapor-heat coupling process, a comprehensive encrypted mesh generation is achieved for the complex water-vapor-heat coupling process in the subgrade having the double-layer polyurethane grouting thermal insulation structure, thereby providing strong technical support for engineering design and optimization.

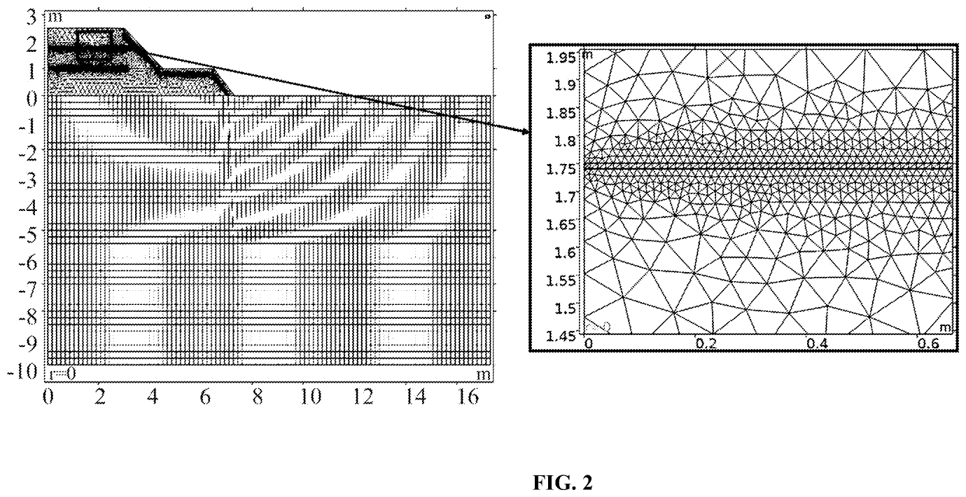

Specifically, in the embodiments, the mesh generation is performed on the subgrade water-vapor-heat coupling geometric model by adopting mapping and a free triangle mesh, and the number of cells and scales in different regions are set to ensure the mesh density and the computational accuracy in a key region (such as a polyurethane thermal insulation layer and a junction between different soil layers). As shown in FIG. 2, in the embodiments, the mapping mesh generation is performed on the strongly-weathered mudstone region and the gravel region. 18 cells are set on the vertical boundary of the strongly-weathered mudstone region, and 100 cells are set on the horizontal boundary. Free triangle mesh generation is performed on the region corresponding to the polyurethane thermal insulation layer and the region corresponding to crushed stones and gravels according to geometries and computational requirements. The region between two black lines in FIG. 2 shows the mesh generation of the thermal insulation layer. 22 cells are set on the vertical boundary of the gravel region, 100 cells are set on the horizontal boundary, and the scaling ratio is adjusted to adapt to different regions. For example, in the embodiments, the region corresponding to the polyurethane thermal insulation layer may be selected, the horizontal proportion in the scaling geometry is set to 1, and the vertical proportion is set to 1. The region corresponding to crushed stones and gravels with the free triangle meshes may also be selected, the horizontal proportion in the scaling geometry is set to 6, and the vertical proportion is set to 6.

In S5, soil temperatures and unfrozen water contents at different depths are selected as initial data, and a simulation solution is performed on the meshing model to obtain a water-vapor-heat coupling simulation result.

In the embodiments, soil temperatures and unfrozen water contents at different depths measured on site may be adopted as initial data. The initial data includes an initial soil temperature and an initial unfrozen water content. The use of the measured data can ensure that an initial state of the simulation coincides with actual conditions, thereby improving the reliability of the simulation result. In the embodiments, by taking data about soil temperatures and unfrozen water contents measured on site or theoretically predicted at different depths as the initial data and in conjunction with the partial differential equation, the relationship between the physical fields, the temperature boundary condition, the water boundary condition, and the material property parameters of different material layers, the meshing model is calculated by using a transient solver to simulate the water migration, the heat transfer, and the phase change process inside the subgrade and analyze the impact of the polyurethane thermal insulation layer on the subgrade performance. In the embodiments, the computational step of the simulation solution may be set to 4 hours, and the total computation time is 1 year.

In S6, the impact of the double-layer polyurethane grouting thermal insulation structure on a temperature distribution, a freeze-thaw cycle depth, and water migration of the subgrade is analyzed according to the water-vapor-heat coupling simulation result.

In the embodiments, data visualization may be performed on the water-vapor-heat coupling simulation result to analyze the impact of the polyurethane thermal insulation layer on the subgrade water-vapor-heat coupling process, and then the impact of the polyurethane layer on the temperature profile, the freeze-thaw depth, and the water distribution of the subgrade can be quantitatively analyzed to assess the thermal insulation effect of the polyurethane layer and the effect of the polyurethane layer on improvement of the stability of the subgrade.

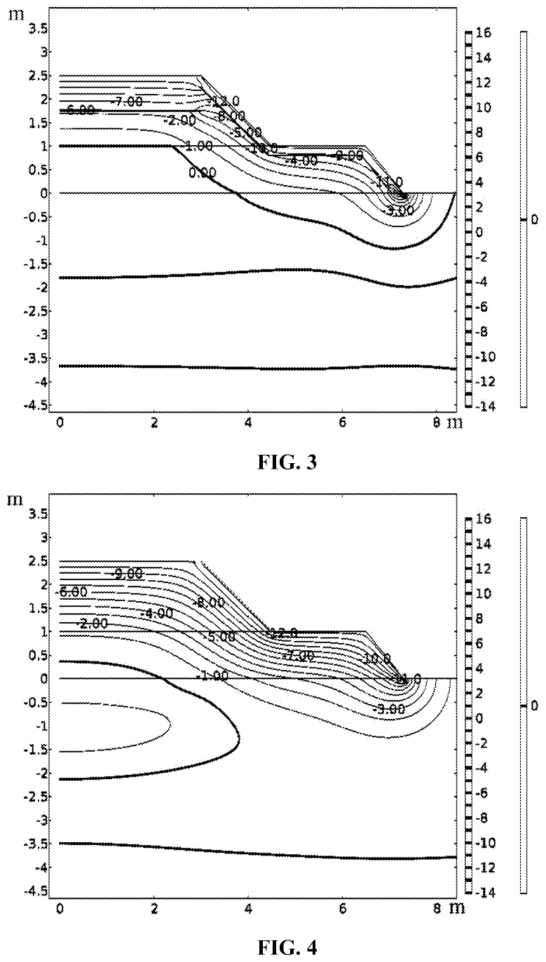

FIGS. 3 and 4 show the temperature field contours of the grouting subgrade and the natural subgrade in winter, respectively. The discontinuous line in FIG. 3 represents the polyurethane layer. The temperature change of the grouting subgrade having the polyurethane layer is discontinuous, and the soil temperature difference between the upper and lower regions of the shallow polyurethane layer and the soil temperature difference between the upper and lower regions of the deep polyurethane layer in the grouting subgrade are 6° C. and 2° C., respectively. The temperature change of the natural subgrade having no polyurethane layer is continuous. Furthermore, the depth of the 0° C. isotherm indicates the freezing depth, and the freezing depth at the center of the grouting subgrade is 0.65 m shallower than the freezing depth at the center of the natural subgrade, indicating that the polyurethane layer reduces the freezing depth and thus reduces the freeze-thaw weathering.

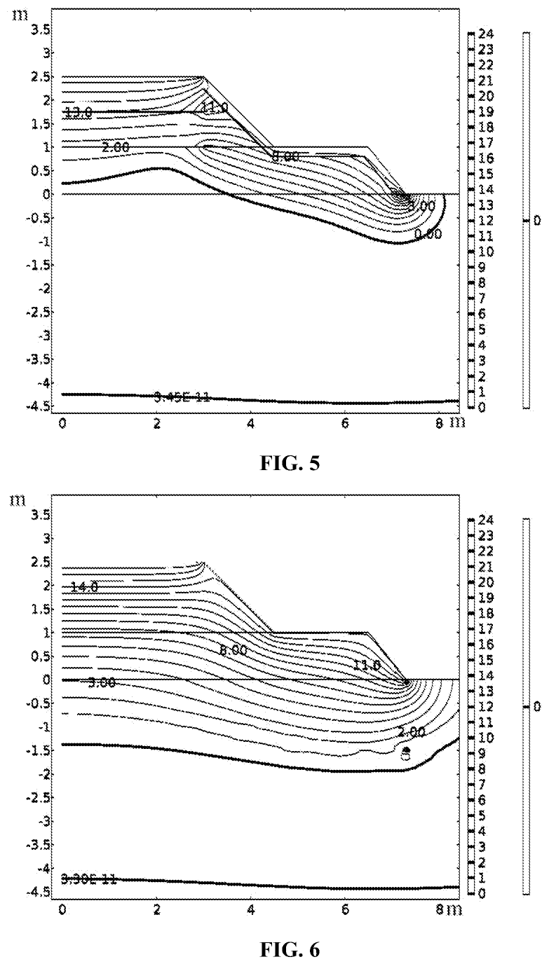

FIGS. 5 and 6 show the temperature contours of the grouting subgrade and the natural subgrade in winter, respectively. The soil temperature difference between the upper and lower regions of the shallow polyurethane layer and the soil temperature difference between the upper and lower regions of the deep polyurethane layer in the grouting subgrade are 7° C. and 2° C., respectively. The shallow polyurethane layer intercepts most of the heat and plays a major role in thermal insulation. As can be seen from FIGS. 5 and 6, the thawing depth at the center of the grouting subgrade is 1.65 m shallower than the intra-day thawing depth at the center of the natural subgrade, indicating that the polyurethane layer can reduce the thaw settlement of the subgrade.

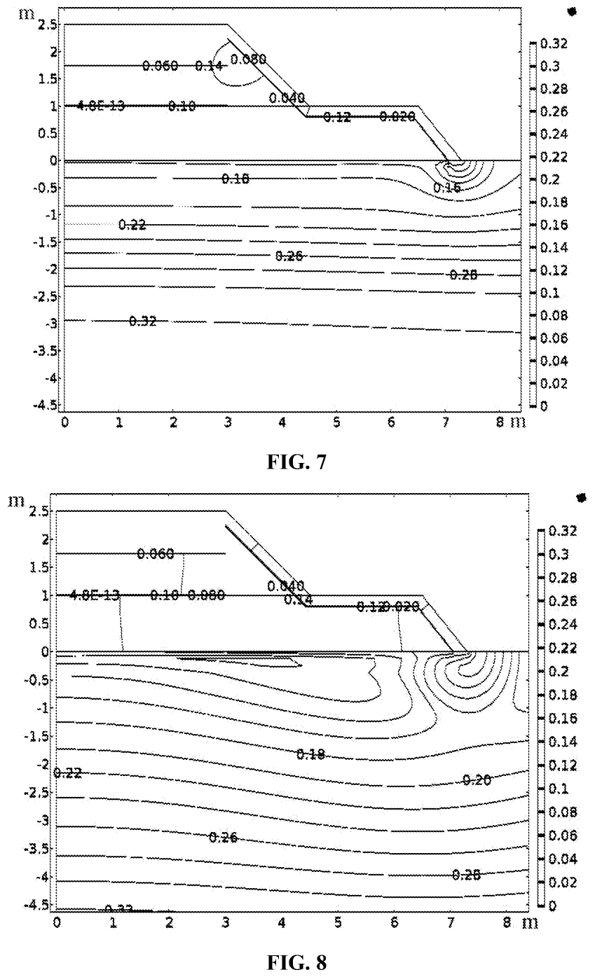

As can be seen from FIG. 7, the volumetric water content of the soil above the shallow polyurethane layer is 0.1, with 45.9% of liquid water frozen, and below the polyurethane layer, the volumetric water content is 0.16, with only 13.5% of liquid water converted to solid ice. The shallow polyurethane layer prevents 32.4% of liquid water from freezing. As can be seen from FIG. 8, the water content between the polyurethane layers is significantly higher than the water content in the other regions, because the evaporation migration of vapor is impeded and the vapor condenses into liquid water underneath the polyurethane layer and converges there. The polyurethane layer affects the water distribution by impeding evaporation and drainage processes.

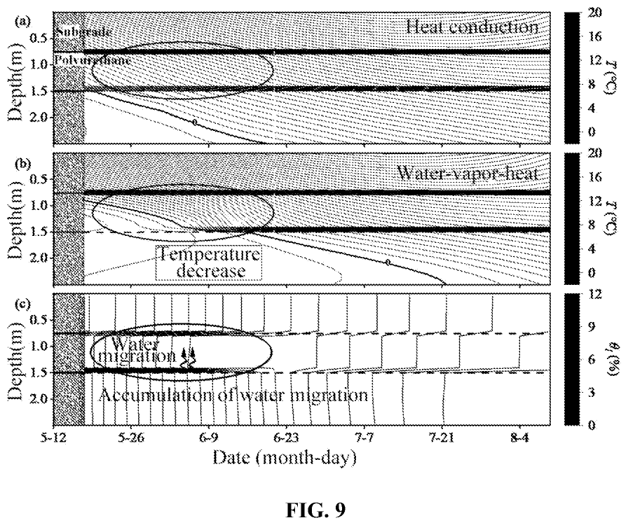

FIG. 9 reveals the effect of the temperature on the vapor migration and a liquid water flow. Specifically, (a) in FIG. 9 and (b) in FIG. 9 present a temperature change curve when only the heat transfer process is considered and a temperature change curve when both the heat transfer process and the water-vapor-heat interaction process are considered, respectively. Through a comparative analysis, there is a significant difference in the temperature distribution in the early thawing stage (from May 20 to June 20), suggesting that the convection of water has a significant effect on the temperature distribution. Through further observation, the upper-bound depth of the permafrost in (b) in FIG. 9 is reduced by 0.6 m compared to the upper-bound depth in (a) in FIG. 9, further confirming the significant effect of the mass transfer process on the temperature distribution. In addition, (c) in FIG. 9 reveals the phenomenon of the accumulation of a large amount of liquid water between the polyurethane (PU) layers. This phenomenon occurs because vapor migrates to the PU layers and condenses into liquid water there, and at the same time, vapor is also hindered by the PU layers and condenses into liquid water. The accumulation of liquid water not only affects the heat transfer efficiency, but also leads to a decrease in the local temperature.

In the embodiments, the subgrade water-vapor-heat coupling geometric model of the double-layer polyurethane grouting thermal insulation structure is constructed based on COMSOL Multiphysics to achieve the direct coupling of multi-physical fields. The secondary development is performed through the partial differential equation (PDE) module in the simulation software, and the actual situations of the temperature profile, the freeze-thaw depth, and the water distribution in the permafrost subgrade are acquired by using numerical computation software. It is proven that polyurethane polymers have an excellent thermal insulation ability and can reduce the depth of air temperature disturbance, and the freezing depth and the thawing depth of the subgrade can be reduced by 0.65 m and 1.65 m, respectively. During the freezing period, the upper PU layer generates a temperature difference of 6° C. between the upper and lower layers of the subgrade, thereby preventing 32.4% of the liquid water from freezing. Similarly, during the thawing period, the upper PU layer induces a temperature difference of up to 7° C. It is also shown through analysis that in the double-layer PU structure, the upper PU layer is used as the main barrier to prevent heat transfer between the upper and lower layers of the subgrade, and the lower PU layer further reinforces the thermal insulation property.

The embodiments of the present disclosure provide a grouting subgrade water-vapor-heat coupling simulation method. The method includes the following steps: a two-dimensional axisymmetric subgrade water-vapor-heat coupling geometric model is constructed; a partial differential equation of a subgrade water-vapor-heat coupling process is acquired, and a relationship between physical fields is established; material property parameters of different material layers in the subgrade water-vapor-heat coupling geometric model are defined, and a temperature and water boundary condition is set in the subgrade water-vapor-heat coupling geometric model; mesh generation is performed on the subgrade water-vapor-heat coupling geometric model by using mapping and a free triangular mesh, and mesh encryption is performed on a polyurethane thermal insulation layer and a surrounding region of the polyurethane thermal insulation layer to obtain a meshing model; soil temperatures and unfrozen water contents at different depths are selected as initial data, and a simulation solution is performed on the meshing model to obtain a water-vapor-heat coupling simulation result; and the impact of the double-layer polyurethane grouting thermal insulation structure on a temperature distribution, a freeze-thaw cycle depth, and water migration of the subgrade is analyzed according to the water-vapor-heat coupling simulation result. Compared with the existing art, the method provided by the embodiments simulates the water migration, the heat transfer, and the phase change process inside the subgrade by using a numerical simulation method to assess the impact of the polyurethane thermal insulation layer on the water-vapor-heat coupling process of the subgrade and analyze the impact of the polyurethane thermal insulation layer on the stability and durability of the subgrade, thereby implementing the simulation study on the subgrade having the double-layer polyurethane grouting thermal insulation structure under the action of water-vapor-heat coupling and providing a theoretical basis for optimizing the thermal insulation design and improving the stability and durability of the subgrade.

It is to be noted that the serial numbers of the above processes do not imply the order of execution, and the order of execution of the processes should be determined by their functions and internal logics, without constituting any limitation on the implementation process of the embodiments of the present application.

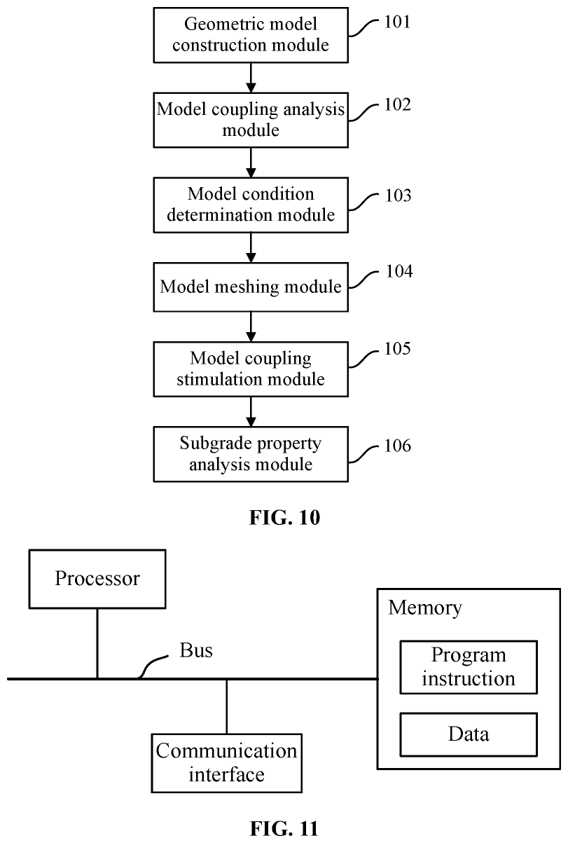

In an embodiment, as shown in FIG. 10, the embodiments of the present disclosure provide a grouting subgrade water-vapor-heat coupling simulation system. The system includes a geometric model construction module 101, a model coupling analysis module 102, a model condition determination module 103, a model meshing module 104, a model coupling stimulation module 105, and a subgrade property analysis module 106.

The geometric model construction module 101 is configured to construct a two-dimensional axisymmetric subgrade water-vapor-heat coupling geometric model according to a physical size and a position parameter of a subgrade and a physical size and a position parameter of a double-layer polyurethane grouting thermal insulation structure.

The model coupling analysis module 102 is configured to acquire a partial differential equation of a subgrade water-vapor-heat coupling process and establish a relationship between physical fields.

The model condition determination module 103 is configured to define material property parameters of different material layers in the subgrade water-vapor-heat coupling geometric model and set a temperature and water boundary condition in the subgrade water-vapor-heat coupling geometric model.

The model meshing module 104 is configured to perform mesh generation on the subgrade water-vapor-heat coupling geometric model by using mapping and a free triangular mesh and perform mesh encryption on a polyurethane thermal insulation layer and a surrounding region of the polyurethane thermal insulation layer to obtain a meshing model.

The model coupling stimulation module 105 is configured to select soil temperatures and unfrozen water contents at different depths as initial data and perform a simulation solution on the meshing model to obtain a water-vapor-heat coupling simulation result.

The subgrade property analysis module 106 is configured to analyze the impact of the double-layer polyurethane grouting thermal insulation structure on a temperature distribution, a freeze-thaw cycle depth, and water migration of the subgrade according to the water-vapor-heat coupling simulation result.

For specific limitations on the grouting subgrade water-vapor-heat coupling simulation system, reference may be made to the limitations on the grouting subgrade water-vapor-heat coupling simulation described above, and the details are not repeated here. Those of ordinary skill in the art may realize that the various modules and steps described in conjunction with the embodiments disclosed in the present application can be implemented in hardware, software or a combination of both. Whether these functions are performed in hardware or software depends on the specific application and design constraints of the technical solution. Those skilled in the art may use different methods to implement the described functions for each specific application, but such implementation should not be considered to be beyond the scope of the present application.

The embodiments of the present disclosure provide a grouting subgrade water-vapor-heat coupling simulation system. The system constructs a two-dimensional axisymmetric subgrade water-vapor-heat coupling geometric model through the geometric model construction module; acquires a partial differential equation of a subgrade water-vapor-heat coupling process and establishes a relationship between physical fields through the model coupling analysis module; defines material property parameters of different material layers in the subgrade water-vapor-heat coupling geometric model and sets a temperature and water boundary condition in the subgrade water-vapor-heat coupling geometric model through the model condition determination module; performs mesh generation on the subgrade water-vapor-heat coupling geometric model by using mapping and a free triangular mesh and performs mesh encryption on a polyurethane thermal insulation layer and a surrounding region of the polyurethane thermal insulation layer through the model meshing module to obtain a meshing model; selects soil temperatures and unfrozen water contents at different depths as initial data and performs a simulation solution on the meshing model through the model coupling stimulation module to obtain a water-vapor-heat coupling simulation result; and analyzes the impact of the double-layer polyurethane grouting thermal insulation structure on a temperature distribution, a freeze-thaw cycle depth, and water migration of the subgrade according to the water-vapor-heat coupling simulation result. Compared with the existing art, the system provided by the embodiments simulates the water migration, the heat transfer, and the phase change process inside the subgrade by using a numerical simulation method to assess the impact of the polyurethane thermal insulation layer on the water-vapor-heat coupling process of the subgrade and analyze the impact of the polyurethane thermal insulation layer on the stability and durability of the subgrade, thereby implementing the simulation study on the subgrade having the double-layer polyurethane grouting thermal insulation structure under the action of water-vapor-heat coupling and providing a theoretical basis for optimizing the thermal insulation design and improving the stability and durability of the subgrade.

FIG. 11 shows a computer device provided by an embodiment of the present disclosure. The computer device includes a processor, a memory, and a transceiver which are connected to each other via bus. The memory is used for storing a set of computer program instructions and data and may transmit the stored data to the processor, and the processor may execute the program instructions stored in the memory to perform the steps of the method described above.

The memory may include a volatile memory or a non-volatile memory or may include both a volatile memory and a non-volatile memory. The processor may be a central processing unit, a microprocessor, an application-specific integrated circuit, a programmable logic device or a combination thereof. By way of illustration but not limitation, the above programmable logic device may be a complex programmable logic device, a field-programmable logic gate array, a generic array logic or any combination thereof.

In addition, the memory may be a physically separate unit or may be integrated into the processor.

It is to be understood by those of ordinary skill in the art that the structure illustrated in FIG. 11 is only a block diagram of a portion of the structure relevant to the technical solutions of the present application and does not constitute a limitation on the computer device to which the technical solutions of the present application are applied. The specific computer device may include more or fewer components than those shown in the drawings, combine some components, or have the same component arrangement.

In an embodiment, the embodiments of the present disclosure provide a non-transitory computer-readable storage medium storing a computer program. When the computer program is executed, the steps of the method described above are performed.

In the grouting subgrade water-vapor-heat coupling simulation method and system, the device and the medium provided by the embodiments of the present disclosure, the grouting subgrade water-vapor-heat coupling simulation method implements the simulation study on the subgrade having the double-layer polyurethane grouting thermal insulation structure under the action of water-vapor-heat coupling, thereby not only improving the precision of the model and the reliability of the simulation results but also comprehensively simulating the physical processes of the subgrade under complex environments. Through the visualization and analysis of the results, the positive impact of the polyurethane thermal insulation layer on the stability and durability of the subgrade is assessed, thereby providing a scientific and quantitative theoretical basis for subgrade engineering.

The embodiments described above may be implemented in whole or in part by software, hardware, firmware, or any combination thereof. When implemented by software, the embodiments may be implemented in whole or in part in the form of a computer program product. The computer program product includes one or more computer instructions. When the computer program instructions are loaded and executed on a computer, the flows or functions described in the embodiments of the present disclosure are generated in whole or in part. The computer may be a general-purpose computer, a special-purpose computer, a computer network or another programmable apparatus. The computer instructions may be stored in a non-transitory computer-readable storage medium, or transmitted from a non-transitory computer-readable storage medium to another non-transitory computer-readable storage medium. For example, the computer instructions may be transmitted from a website, computer, server or data center to another website, computer, server or data center in a wired manner (for example, through a coaxial cable, an optical fiber or a digital subscriber line) or in a wireless manner (for example, in an infrared, wireless or microwave manner). The non-transitory computer-readable storage medium may be any available medium that can be accessed by a computer or an integrated data storage device such as a server, a data center or the like that includes one or more available media. The available medium may be a magnetic medium (for example, a floppy disk, a hard disk, and a magnetic tape), an optical medium (for example, a digital video disk (DVD)), a semiconductor medium (for example, a solid-state drive (SSD)), or the like.

It is to be understood by those of ordinary skill in the art that all or part of the flows of the method in the preceding embodiments may be implemented by related hardware instructed by a computer program. The computer program may be stored in a non-transitory computer-readable storage medium. When the computer program is executed, flows including the flows in the method embodiments described above may be implemented.

The above embodiments are merely several preferred embodiments of the present application, and the specific and detailed description thereof cannot be understood as a limit to the scope of the present disclosure. It is to be noted that for those of ordinary skill in the art, improvements and substitutions can be made without departing from the principle of the present disclosure, and these improvements and substitutions are within the scope of the present disclosure. Therefore, the scope of the present application is subject to the scope of the appended claims.

What is claimed is:

1. A grouting subgrade water-vapor-heat coupling simulation method, comprising:
constructing a two-dimensional axisymmetric subgrade water-vapor-heat coupling geometric model according to a physical size and a position parameter of a subgrade and a physical size and a position parameter of a double-layer polyurethane grouting thermal insulation structure;
acquiring a partial differential equation of a subgrade water-vapor-heat coupling process, and establishing a relationship between physical fields;
defining material property parameters of different material layers in the subgrade water-vapor-heat coupling geometric model, and setting a temperature boundary condition and a water boundary condition in the subgrade water-vapor-heat coupling geometric model;
performing mesh generation on the subgrade water-vapor-heat coupling geometric model by using mapping and a free triangular mesh, and performing mesh encryption on a polyurethane thermal insulation layer and a surrounding region of the polyurethane thermal insulation layer to obtain a meshing model;
selecting soil temperatures and unfrozen water contents at different depths as initial data, and performing a simulation solution on the meshing model to obtain a water-vapor-heat coupling simulation result; and
according to the water-vapor-heat coupling simulation result, analyzing an impact of the double-layer polyurethane grouting thermal insulation structure on a temperature distribution, a freeze-thaw cycle depth, and water migration of the subgrade.

2. The grouting subgrade water-vapor-heat coupling simulation method of claim 1, wherein the partial differential equation comprises a water parabolic partial differential equation, and the water parabolic partial differential equation is specifically:
$${d}_{w} \frac{\partial S}{\partial t} + ∇ * {γ}_{w} + aS = {f}_{w} wherein$$
$${d}_{w} = ( {θ}_{s} - {θ}_{r} ) [ 1 + \frac{{ρ}_{i}}{{ρ}_{l}} {B}_{i} ( T ) - \frac{{ρ}_{v}}{{ρ}_{l}} {B}_{i} ( T ) - \frac{{ρ}_{v}}{{ρ}_{l}} ]$$
$${γ}_{w} = - [ {K}_{lh} ∇ ( {h}_{m} + y ) + {K}_{lT} ∇ T ] - \frac{{ρ}_{v}}{{ρ}_{l}} [ {K}_{vh} ∇ {h}_{m} + {K}_{vT} ∇ T ]$$
$$a = ( \frac{{ρ}_{i}}{{ρ}_{l}} - \frac{{ρ}_{v}}{{ρ}_{l}} ) ( {θ}_{s} - {θ}_{r} ) \frac{\partial B}{\partial T} * \frac{\partial T}{\partial t}$$
$${f}_{w} = - [ ( \frac{{ρ}_{i}}{{ρ}_{l}} - \frac{{ρ}_{v}}{{ρ}_{l}} ) * {θ}_{r} * \frac{\partial B}{\partial T} * \frac{\partial T}{\partial t} ]$$
$${B}_{i} ( T ) = \frac{{θ}_{i}}{{θ}_{l}} = \{ \begin{matrix}1.1 * {( \frac{T}{{T}_{f}} )}^{B} - 1 & T < {T}_{f} \\ 0 & T \geq {T}_{f}\end{matrix}$$
wherein in the equation, d_{w} denotes a damping coefficient of a water coefficient partial differential equation; S denotes saturation of soil; t denotes time in seconds; γ_{w} denotes a conservation flux source item of the water coefficient partial differential equation; α denotes a conservation flux convection coefficient; f_{w} denotes a source item of the water coefficient partial differential equation; θₛ denotes a saturated water content of a soil mass; θᵣ denotes a residual water content of the soil mass; ρᵢ denotes a density of ice; ρₗ denotes a density of liquid water; Bᵢ(T) denotes a ratio of a pore ice volume to an unfrozen water volume; ρᵥ denotes a density of vapor; Kₗₕ denotes an isothermal hydraulic conductivity derivative; ∇ denotes a Laplace operator; hₘ denotes a pressure head; y denotes an ordinate of spatial coordinates of the soil mass; K_{lT} denotes a non-isothermal hydraulic conductivity derivative; T denotes a temperature; Kᵥₕ denotes an isothermal vapor hydraulic conductivity; K_{vT} denotes a non-isothermal vapor hydraulic conductivity; θᵢ denotes a volume content of ice in soil; θₗ denotes a volume content of unfrozen water in soil; T_{f} denotes a freezing temperature; and B denotes an empirical constant.

3. The grouting subgrade water-vapor-heat coupling simulation method of claim 2, wherein the partial differential equation further comprises a heat conduction parabolic partial differential equation, and the heat conduction parabolic partial differential equation is specifically:
$${d}_{h} \frac{\partial T}{\partial t} + ∇ * ( - λ ∇ T - α T + {γ}_{h} ) = {f}_{h} wherein$$
$${d}_{h} = \{ C - {L}_{i} {ρ}_{i} [ S ( {θ}_{s} - {θ}_{r} ) + {θ}_{r} ] \frac{\partial B}{\partial T} - {L}_{v} {ρ}_{v} [ S ( {θ}_{s} - {θ}_{r} ) + {θ}_{r} ] \frac{\partial B}{\partial T} \}$$
$$α = {C}_{l} {q}_{l} + {C}_{v} {q}_{v}$$
$${γ}_{h} = {L}_{v} {ρ}_{v} ∇ {q}_{v}$$
$${f}_{h} = ( {L}_{i} {ρ}_{i} B + {L}_{v} {ρ}_{v} B + {L}_{v} {ρ}_{v} ) [ ( {θ}_{s} - {θ}_{r} ) \frac{\partial S}{\partial t} ]$$
wherein in the equation, dₕ denotes a damping coefficient of a heat conduction coefficient partial differential equation; λ denotes a heat transfer coefficient of soil; α denotes an absorption coefficient; γₕ denotes a conservation flux source item of the heat conduction coefficient partial differential equation; fₕ denotes a source item of the heat conduction coefficient partial differential equation; C denotes a volumetric heat capacity of soil; Lᵢ denotes a latent heat value for water freezing; S denotes saturation of soil; Lᵥ denotes a latent heat value for water vaporization; Cₗ denotes a volumetric heat capacity of liquid water; qₗ denotes a liquid water flux in soil; Cᵥ denotes a volumetric heat capacity of vapor; and qᵥ denotes a vapor flux.

4. The grouting subgrade water-vapor-heat coupling simulation method of claim 1, wherein the material property parameters comprise a hydrothermal physical parameter of the subgrade and a soil layer, and a thermal physical parameter of polyurethane;
wherein the hydrothermal physical parameter of the subgrade and the soil layer comprise a dry density, a specific heat capacity of a thawed soil, a specific heat capacity of a frozen soil, a heat transfer coefficient of the thawed soil, a heat transfer coefficient of the frozen soil, a porosity, a saturated water content, and a residual water content; and
the thermal physical parameter of the polyurethane comprises a dry density of the polyurethane, a heat transfer coefficient of the polyurethane, and a specific heat capacity of the polyurethane.

5. The grouting subgrade water-vapor-heat coupling simulation method of claim 1, wherein the temperature and water boundary condition comprise a top temperature boundary condition, a bottom heat flux boundary condition, a side adiabatic boundary condition, and a circumambient zero flux water boundary condition of the subgrade water-vapor-heat coupling geometric model; wherein the top temperature boundary condition comprises a thermal boundary condition of a top surface of the subgrade, a thermal boundary condition of a side slope of the subgrade, and a thermal boundary condition of a natural surface; and
the top temperature boundary condition is in a form of a sinusoidal function which is specifically:
$$R = {T}_{a} + \frac{k}{365} {t}_{a} + A sin ( \frac{2 π}{365} {t}_{a} + φ )$$
wherein in the equation, R denotes a temperature varying with the sinusoidal function; T_{α} denotes an annual average shallow soil temperature; k denotes an annual warming rate; t_{α} denotes time in days; A denotes an annual shallow soil temperature amplitude; and φ denotes an initial phase of soil.

6. The grouting subgrade water-vapor-heat coupling simulation method of claim 1, wherein steps of performing mesh generation on the subgrade water-vapor-heat coupling geometric model by using mapping and a free triangular mesh and performing mesh encryption on a polyurethane thermal insulation layer and a surrounding region of the polyurethane thermal insulation layer to obtain a meshing model comprise:
with minimizing a mesh global error of the subgrade water-vapor-heat coupling geometric model as a goal, performing global mesh iterative refinement on the subgrade water-vapor-heat coupling geometric model a plurality of times to obtain a globally optimized mesh;
defining a subgrade water state-based integral along a subgrade boundary as a water state boundary error index according to a subgrade water state spatial distribution data of the subgrade water-vapor-heat coupling geometric model;
identifying a water-vapor-heat coupling key feature region from the globally optimized mesh by using the water state boundary error index according to a geometric feature of the subgrade water-vapor-heat coupling geometric model, the temperature boundary condition, and the water boundary condition;
quantifying an intra-mesh physical field coupling effect according to water migration and heat exchange on a boundary of the water-vapor-heat coupling key feature region, and constructing a multi-physical field coupling effect evaluation matrix by using a Gaussian integral;
performing local adaptive mesh generation on the globally optimized mesh by using the water state boundary error index and according to the multi-physical field coupling effect evaluation matrix to obtain a locally optimized mesh;
mapping the locally optimized mesh to the different material layers of the subgrade water-vapor-heat coupling geometric model by using a mapping method, and performing mesh refinement on the different material layers by using a free triangle mesh generation method and according to physical properties of the different material layers in the subgrade water-vapor-heat coupling geometric model to obtain a layered mesh model; wherein the material layers comprise a double-layer polyurethane thermal insulation layer and a subgrade material layer; and
performing the mesh encryption on a water-vapor-heat coupling key feature region in the layered mesh model according to a predetermined scaling ratio to obtain the meshing model.

7. The grouting subgrade water-vapor-heat coupling simulation method of claim 1, further comprising: performing a water-vapor-heat coupling simulation solution on the meshing model by using a transient solver.

8. A computer device, comprising a processor and a memory, wherein the processor is connected to the memory, the memory is used for storing a computer program, and the processor is used for executing the computer program stored in the memory to cause the computer device to perform:
constructing a two-dimensional axisymmetric subgrade water-vapor-heat coupling geometric model according to a physical size and a position parameter of a subgrade and a physical size and a position parameter of a double-layer polyurethane grouting thermal insulation structure;
acquiring a partial differential equation of a subgrade water-vapor-heat coupling process, and establishing a relationship between physical fields;
defining material property parameters of different material layers in the subgrade water-vapor-heat coupling geometric model, and setting a temperature boundary condition and a water boundary condition in the subgrade water-vapor-heat coupling geometric model;
performing mesh generation on the subgrade water-vapor-heat coupling geometric model by using mapping and a free triangular mesh, and performing mesh encryption on a polyurethane thermal insulation layer and a surrounding region of the polyurethane thermal insulation layer to obtain a meshing model;
selecting soil temperatures and unfrozen water contents at different depths as initial data, and performing a simulation solution on the meshing model to obtain a water-vapor-heat coupling simulation result; and
according to the water-vapor-heat coupling simulation result, analyzing an impact of the double-layer polyurethane grouting thermal insulation structure on a temperature distribution, a freeze-thaw cycle depth, and water migration of the subgrade.

9. The computer device of claim 8, wherein the partial differential equation comprises a water parabolic partial differential equation, and the water parabolic partial differential equation is specifically:
$${d}_{w} \frac{\partial S}{\partial t} + ∇ * {γ}_{w} + aS = {f}_{w} wherein$$
$${d}_{w} = ( {θ}_{s} - {θ}_{r} ) [ 1 + \frac{{ρ}_{i}}{{ρ}_{l}} {B}_{i} ( T ) - \frac{{ρ}_{v}}{{ρ}_{l}} ]$$
$${γ}_{w} = - [ {K}_{lh} ∇ ( {h}_{m} + y ) + {K}_{lT} ∇ T ] - \frac{{ρ}_{v}}{{ρ}_{l}} [ {K}_{vh} ∇ {h}_{m} + {K}_{vT} ∇ T ]$$
$$a = ( \frac{{ρ}_{i}}{{ρ}_{l}} - \frac{{ρ}_{v}}{{ρ}_{l}} ) ( {θ}_{s} - {θ}_{r} ) \frac{\partial B}{\partial T} * \frac{\partial T}{\partial t}$$
$${f}_{w} = - [ ( \frac{{ρ}_{i}}{{ρ}_{l}} - \frac{{ρ}_{v}}{{ρ}_{l}} ) * {θ}_{r} * \frac{\partial B}{\partial T} * \frac{\partial T}{\partial t} ]$$
$${B}_{i} ( T ) = \frac{{θ}_{i}}{{θ}_{l}} = \{ \begin{matrix}1.1 * {( \frac{T}{{T}_{f}} )}^{B} - 1 & T < {T}_{f} \\ 0 & T \geq {T}_{f}\end{matrix}$$
wherein in the equation, d_{w} denotes a damping coefficient of a water coefficient partial differential equation; S denotes saturation of soil; t denotes time in seconds; γ_{w} denotes a conservation flux source item of the water coefficient partial differential equation; α denotes a conservation flux convection coefficient; f_{w} denotes a source item of the water coefficient partial differential equation; θₛ denotes a saturated water content of a soil mass; θᵣ denotes a residual water content of the soil mass; ρᵢ denotes a density of ice; ρₗ denotes a density of liquid water; Bᵢ(T) denotes a ratio of a pore ice volume to an unfrozen water volume; ρᵥ denotes a density of vapor; Kₗₕ denotes an isothermal hydraulic conductivity derivative; ∇ denotes a Laplace operator; hₘ denotes a pressure head; y denotes an ordinate of spatial coordinates of the soil mass; K_{lT} denotes a non-isothermal hydraulic conductivity derivative; T denotes a temperature; Kᵥₕ denotes an isothermal vapor hydraulic conductivity; K_{vT} denotes a non-isothermal vapor hydraulic conductivity; θᵢ denotes a volume content of ice in soil; θₗ denotes a volume content of unfrozen water in soil; T_{f} denotes a freezing temperature; and B denotes an empirical constant.

10. The computer device of claim 9, wherein the partial differential equation further comprises a heat conduction parabolic partial differential equation, and the heat conduction parabolic partial differential equation is specifically:
$${d}_{h} \frac{\partial T}{\partial t} + ∇ * ( - λ ∇ T - α T + {γ}_{h} ) = {f}_{h} wherein$$
$${d}_{h} = \{ C - {L}_{i} {ρ}_{i} [ S ( {θ}_{s} - {θ}_{r} ) + {θ}_{r} ] \frac{\partial B}{\partial T} - {L}_{v} {ρ}_{v} [ S ( {θ}_{s} - {θ}_{r} ) + {θ}_{r} ] \frac{\partial B}{\partial T} \}$$
$$α = {C}_{l} {q}_{l} + {C}_{v} {q}_{v}$$
$${γ}_{h} = {L}_{v} {ρ}_{v} ∇ {q}_{v}$$
$${f}_{h} = ( {L}_{i} {ρ}_{i} B + {L}_{v} {ρ}_{v} B + {L}_{v} {ρ}_{v} ) [ ( {θ}_{s} - {θ}_{r} ) \frac{\partial S}{\partial t} ]$$
wherein in the equation, dₕ denotes a damping coefficient of a heat conduction coefficient partial differential equation; λ denotes a heat transfer coefficient of soil; α denotes an absorption coefficient; γₕ denotes a conservation flux source item of the heat conduction coefficient partial differential equation; fₕ denotes a source item of the heat conduction coefficient partial differential equation; C denotes a volumetric heat capacity of soil; Lᵢ denotes a latent heat value for water freezing; S denotes saturation of soil; Lᵥ denotes a latent heat value for water vaporization; Cₗ denotes a volumetric heat capacity of liquid water; qₗ denotes a liquid water flux in soil; Cᵥ denotes a volumetric heat capacity of vapor; and qᵥ denotes a vapor flux.

11. The computer device of claim 8, wherein the material property parameters comprise a hydrothermal physical parameter of the subgrade and a soil layer, and a thermal physical parameter of polyurethane;
wherein the hydrothermal physical parameter of the subgrade and the soil layer comprise a dry density, a specific heat capacity of a thawed soil, a specific heat capacity of a frozen soil, a heat transfer coefficient of the thawed soil, a heat transfer coefficient of the frozen soil, a porosity, a saturated water content, and a residual water content; and
the thermal physical parameter of the polyurethane comprises a dry density of the polyurethane, a heat transfer coefficient of the polyurethane, and a specific heat capacity of the polyurethane.

12. The computer device of claim 8, wherein the temperature and water boundary condition comprise a top temperature boundary condition, a bottom heat flux boundary condition, a side adiabatic boundary condition, and a circumambient zero flux water boundary condition of the subgrade water-vapor-heat coupling geometric model; wherein the top temperature boundary condition comprises a thermal boundary condition of a top surface of the subgrade, a thermal boundary condition of a side slope of the subgrade, and a thermal boundary condition of a natural surface; and
the top temperature boundary condition is in a form of a sinusoidal function which is specifically:
$$R = {T}_{a} + \frac{k}{365} {t}_{a} + A sin ( \frac{2 π}{365} {t}_{a} + φ )$$
wherein in the equation, R denotes a temperature varying with the sinusoidal function; T_{α} denotes an annual average shallow soil temperature; k denotes an annual warming rate; t_{α} denotes time in days; A denotes an annual shallow soil temperature amplitude; and φ denotes an initial phase of soil.

13. The computer device of claim 8, wherein steps of performing mesh generation on the subgrade water-vapor-heat coupling geometric model by using mapping and a free triangular mesh and performing mesh encryption on a polyurethane thermal insulation layer and a surrounding region of the polyurethane thermal insulation layer to obtain a meshing model comprise:
with minimizing a mesh global error of the subgrade water-vapor-heat coupling geometric model as a goal, performing global mesh iterative refinement on the subgrade water-vapor-heat coupling geometric model a plurality of times to obtain a globally optimized mesh;
defining a subgrade water state-based integral along a subgrade boundary as a water state boundary error index according to a subgrade water state spatial distribution data of the subgrade water-vapor-heat coupling geometric model;
identifying a water-vapor-heat coupling key feature region from the globally optimized mesh by using the water state boundary error index according to a geometric feature of the subgrade water-vapor-heat coupling geometric model, the temperature boundary condition, and the water boundary condition;
quantifying an intra-mesh physical field coupling effect according to water migration and heat exchange on a boundary of the water-vapor-heat coupling key feature region, and constructing a multi-physical field coupling effect evaluation matrix by using a Gaussian integral;
performing local adaptive mesh generation on the globally optimized mesh by using the water state boundary error index and according to the multi-physical field coupling effect evaluation matrix to obtain a locally optimized mesh;
mapping the locally optimized mesh to the different material layers of the subgrade water-vapor-heat coupling geometric model by using a mapping method, and performing mesh refinement on the different material layers by using a free triangle mesh generation method and according to physical properties of the different material layers in the subgrade water-vapor-heat coupling geometric model to obtain a layered mesh model; wherein the material layers comprise a double-layer polyurethane thermal insulation layer and a subgrade material layer; and
performing the mesh encryption on a water-vapor-heat coupling key feature region in the layered mesh model according to a predetermined scaling ratio to obtain the meshing model.

14. The computer device of claim 8, wherein the processor is used for executing the computer program stored in the memory to cause the computer device to perform: performing a water-vapor-heat coupling simulation solution on the meshing model by using a transient solver.

15. A non-transitory computer-readable storage medium storing a computer program, wherein when the computer program is executed, the method of claim 1 is performed.
